(19) United States
(12) Patent Application Publication
(10) Pub. No.: US 2020/0301342 A1
(43) Pub. Date: Sep. 24, 2020

(54) IMAGE PROCESSING APPARATUS, COMPUTER-READABLE MEDIUM, AND IMAGE PROCESSING METHOD

(71) Applicants: Nobuyuki OTAKI, Kanagawa (JP); Yukihiro FUKUNAGA, Kanagawa (JP); Tatsuroh AKABANE, Kanagawa (JP)

(72) Inventors: Nobuyuki OTAKI, Kanagawa (JP); Yukihiro FUKUNAGA, Kanagawa (JP); Tatsuroh AKABANE, Kanagawa (JP)

(73) Assignee: Ricoh Company, Ltd., Tokyo (JP)

(21) Appl. No.: 16/823,910

(22) Filed: Mar. 19, 2020

(30) Foreign Application Priority Data
Mar. 20, 2019 (JP) 2019-052692
Oct. 25, 2019 (JP) 2019-194741

(51) Int. Cl. G03G 15/00; G03G 9/08

(52) U.S. Cl. CPC G03G 15/6585; G03G 9/09; G03G 9/0821

(57) ABSTRACT

An image processing apparatus includes a data analyzing part, and a data generating part. The data analyzing part is configured to refer to original image data for generating a printed material utilizing a first consumable material absorbing a larger amount of visible light than invisible light and a second consumable material absorbing a larger amount of invisible light than visible light, and to a correction data table indicating whether invisible light is absorbed for each density value regarding the first consumable material, and specify a pixel having a density value of the first consumable material and absorbing invisible light in the original image data. The data generating part is configured to correct the density value of the first consumable material in the specified pixel to a density value of a third consumable material not absorbing invisible light, to generate corrected image data.

### CROSS-REFERENCE TO RELATED APPLICATIONS

The present application claims priority under 35 U.S.C. § 119 to Japanese Patent Application. No. 2019-052692, filed on Mar. 20, 2019 and Japanese Patent Application No. 2019-194741, filed on Oct. 25, 2019. The contents of which are incorporated herein by reference in their entirety.

### BACKGROUND OF THE INVENTION

### 1. Field of the Invention

The present invention relates to an image processing apparatus, a computer-readable medium, and an image processing method.

### 2. Description of the Related Art

In recent years, a printing technique of embedding information in an image when printing an image such as a document or photograph has been attracting attention.

Japanese Unexamined Patent Application Publication No. 2003-136828 discloses a technique of printing an image that is visible only when a special judging apparatus such as an infrared camera is used, with process black (black in which cyan, magenta, and yellow are used), which does not absorb infrared rays, and pure black, which absorbs infrared rays.

In this regard, in order to realize a printing technique of embedding information, for example, infrared (IR) toner having absorbency in the wavelength region (around about 850 nm) of infrared light including near-infrared light, while having low absorbency in the wavelength region (about 400 to 700 nm) of visible light, can be used. In this case, for example, when a printed material simultaneously utilizing an IR toner and black toner is scanned with IR toner reading irradiation light to detect printed information of the IR toner, the black toner may absorb the IR irradiation light used for scanning, and a part that is imaged with the black toner may also be detected as the IR toner. As a result, it may cause a problem in that noise is mixed in IR toner information that has been read out, and the printed information of the IR toner cannot be properly transferred or displayed.

In the technique described in Japanese Unexamined Patent Application Publication No. 2003-136828, when printing is performed with pure black and special toner having similar characteristics to pure black, information printed with the special toner also cannot be properly read out.

### SUMMARY OF THE INVENTION

According to an aspect of the present invention, an image processing apparatus includes a data analyzing part, and a data generating part. The data analyzing part is configured to refer to original image data for generating a printed material utilizing a first consumable material absorbing a larger amount of visible light than invisible light and a second consumable material absorbing a larger amount of invisible light than visible light, and to a correction data table indicating whether invisible light is absorbed for each density value regarding the first consumable material, and specify a pixel having a density value of the first consumable material and absorbing invisible light in the original image data. The data generating part is configured to correct the density value of the first consumable material in the specified pixel to a density value of a third consumable material not absorbing invisible light, to generate corrected image data.

### BRIEF DESCRIPTION OF THE DRAWINGS

FIG. 1 is a block diagram illustrating an example of a configuration of an information processing system according to a first embodiment of the present invention;

FIG. 2 is a block diagram for describing a hardware configuration and a function of an image forming apparatus;

FIG. 3 is a block diagram for describing a hardware configuration and a function of a client PC;

FIG. 4 is a block diagram illustrating example of a functional configuration of the information processing system according to the present embodiment;

FIG. 5 is a figure illustrating an example of a correction data table;

FIG. 6 is a flow chart illustrating creation processing of the correction data table;

FIG. 7 is a flow chart for describing IR toner correction processing that is executed by the information processing system according to the first embodiment of the present invention;

FIG. 8 is a flow chart for describing IR toner correction processing that is executed by an information processing system according to a second embodiment of the present invention;

FIG. 9A and FIG. 9B are figures illustrating a flow of creation processing of an IR toner density data table and an IR toner influence detection table according to a third embodiment of the present invention; and

FIG. 10 is a flow chart illustrating detected noise elimination correction processing of IR toner density information that is executed by an information processing system according to the third embodiment of the present invention.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to provide an image processing apparatus, a computer-readable medium, and an image processing method that can improve accuracy of readout of an image that uses special toner such as IR toner.

### First Embodiment

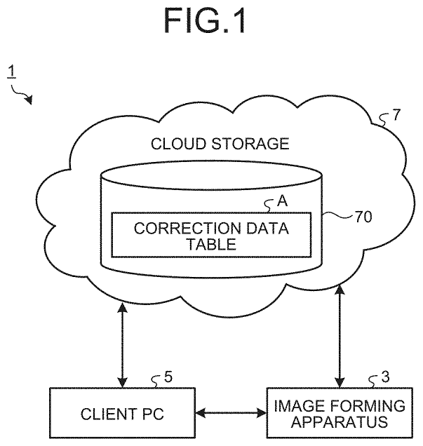

An information processing system according to an embodiment of the present invention will now be described with reference to the attached drawings. FIG. 1 is a block diagram illustrating an example of a configuration of an information processing system 1 according to a first embodiment of the present invention. As illustrated in this figure, the information processing system 1 includes an image forming apparatus 3 as an image processing apparatus, a client PC 5, and a storage part 70 that is provided in a cloud storage 7.

The image forming apparatus 3 is an apparatus that performs print processing of forming characters, images, and the like on a medium such as a printing paper. For example, the image forming apparatus 3 is a multifunction peripheral/product/printer (MFP) that can be used as an image scanner and a fax, a laser printer, or the like. In the present embodiment, a medium such as a paper on which print processing is performed will be referred to as a printed material. The image forming apparatus 3 generates the printed material based on print data that is transmitted from the client PC 5. In particular, the image forming apparatus 3 executes IR toner correction processing, which will be described later, in accordance with the setting.

An IR toner herein refers to a toner having absorbency in the wavelength region (around about 850 nm) of infrared light including near-infrared 1 while having low absorbency in the wavelength region (about 400 to 700 nm) of visible light. With regard to the IR toner, the absorbency in the wavelength region of visible light is lower than the absorbency in the wavelength region of infrared light. On the other hand, with regard to an ordinary black toner, the absorbency in the wavelength region of infrared light is lower than the absorbency in the wavelength region of visible light. In addition, cyan toner, magenta toner, and yellow toner that are used to make process black have almost no absorbency in the wavelength region of infrared light.

The printed material printed with the IR toner transparent (invisible) to visible light, and it becomes legible when being irradiated with infrared light. “Invisible” herein refers to a state in which nothing can be seen at all, and it also includes a state in which something can be slightly seen but what is printed cannot be visually recognized.

The client PC 5 is an image processing apparatus that generates print data for causing the image forming apparatus 3 to execute print processing. For example, the client PC 5 is a personal computer (PC), a tablet terminal, a smartphone, or the like. The client PC 5 includes an interface for connection to a network. Software such as a printer driver, a scan driver, and a predetermined application for performing generation, transmission, and the like of print data based on input operations by a user are installed in the client PC 5. The print data includes information that indicates content of a print job. Data to be printed (image data, text data, and the like), setting information (paper size, number of papers to be printed, and the like), commands, and the like are associated with each print job.

The storage part 70 provided in the cloud storage 7 stores therein a correction data table A, which will be described later. The correction data table A is generated in, for example, the client PC 5 in advance of the IR toner correction processing, which will be described later. In addition, the storage part 70 stores therein various kinds of data transferred from the image forming apparatus 3 and the client PC 5.

The image forming apparatus 3, the client PC 5, and the cloud storage 7 are connected to a network, and are capable of communicating with one another. The network may be Ethernet (registered trademark), a wireless computer communication means such as Wi-Fi, or a wired computer communication means.

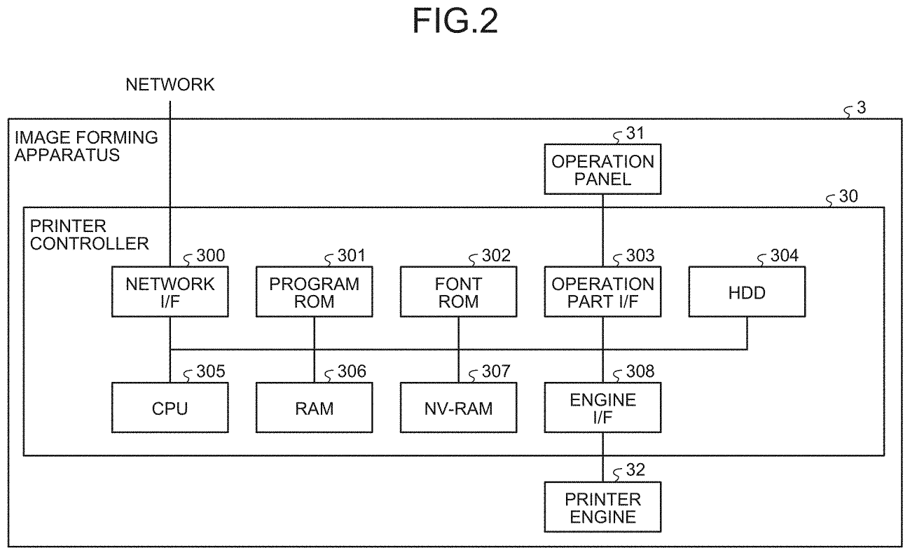

FIG. 2 is a block diagram for describing a hardware configuration and a function of the image forming apparatus 3. As illustrated in FIG. 2, the image forming apparatus 3 includes a printer controller 30, an operation panel 31, and a printer engine 32.

The operation panel 31 is a unit for receiving an input operation to the image forming apparatus 3 by a user. For example, the operation panel 31 is composed by utilizing a liquid crystal panel, a touch panel, a keyboard, and the like.

The printer engine 32 has a mechanism of generating the printed material based on a control signal from the printer controller 30, and discharging the printed material to a predetermined discharge destination. The printer engine 32 is composed of, for example, a paper feeding mechanism of paper-feeding a medium from a paper feeding tray, a light irradiation mechanism of irradiating a photoconductor with laser light output from a laser head, a toner adhesion mechanism of adhering toner to a photoconductor, a transfer/fixing mechanism of transferring/fixing toner to a medium, a discharge mechanism of discharging a medium (printed material) on which toner is fixed to a predetermined discharge destination, and the like.

The printer controller 30 is an electronic control unit that controls the printer engine 32 based on an input operation for the operation panel 31, print data transmitted from the client PC 5, and the like.

The printer controller 30 includes a network interface (I/F) 300, a program read only memory (ROM) 301, a font ROM 302, an operation part I/F 303, a central processing unit (CPU) 305, a random access memory (RAM) 306, a non-volatile RAM (NV-RAM) 307, an engine I/F 308, and a hard disk drive (HDD) 309.

The network I/F 31 is an interface for connecting to a network, and communicating with the client PC 5. The program ROM 301 is a memory that stores therein computer programs for performing management of data within the printer controller 30, control of peripheral modules, a computer program for executing the IR toner correction processing, which will be described later, and the like. The font ROM 302 is a memory that stores therein various kinds of font data to be used for printing. The operation part I/F 303 is an interface for performing reception of an input signal from the operation panel 31, transmission of display data to the operation panel 31, and the like. The CPU 305 is one or a plurality of integrated circuits that executes various kinds of processing based on computer programs stored in the program ROM 301, print data received from the client PC 5, and the like. The RAM 306 functions as a work memory when the CPU 305 executes predetermined program processing, a buffer that temporarily stores therein print data received from the client PC 5, a memory that processes data stored in the buffer, and the like. The NV-RAM 307 is a nonvolatile memory that holds data even after the image forming apparatus 3 is powered off. The engine I/F 308 is an interface for transmitting a control that generated within the printer controller 30 to the printer engine 32, and receiving a feedback signal from the printer engine 32. The HDD 309 is a storage device that stores various kinds of data in a hard disk that is a storage medium.

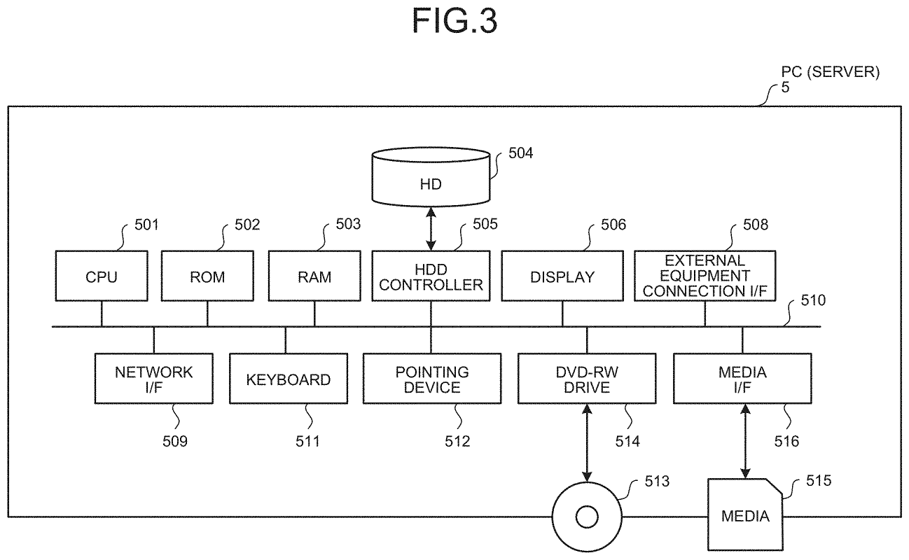

FIG. 3 is a block diagram for describing a hardware configuration and a function of the client PC 5. The client PC 5 is constructed with a computer. As illustrated in FIG. 3, the client PC 5 includes a CPU 501, a ROM 502, a RAM 503, an HD 504, a hard disk drive (HDD) controller 505, a display 506, an external equipment connection interface (I/F) 508, a network I/F 509, a data bus 510, keyboard 511, a pointing device 512, a digital versatile disk rewritable (DVD-RW) drive 514, and a media I/F 516.

Among these, the CPU 501 controls overall operations of the client PC 5. The ROM 502 stores therein a computer program to be used for driving of the CPU 501 such as IPL. The RAM 503 is used as a work area of the CPU 501. The HP 504 stores therein various kinds of data such as computer programs. The HDD controller 505 controls reading or writing of various kinds of data with respect to the HD 504 in accordance with control of the CPU 501. The display 506 displays various kinds of information such as cursors, menus, windows, characters, images, and the like. The external equipment connection I/F 508 is an interface for connecting various kinds of external equipment. The external equipment in this case is, for example, a universal serial bus (USE) memory, a printer, or the like. The network I/F 509 is an interface for performing data communication by utilizing a communication network 100. The bus line 510 is an address bus, a data bus, or the like for electrically connecting each component such as the CPU 501 illustrated in FIG. 3.

In addition, the keyboard 511 type of an input means that includes a plurality of keys for inputting characters, numerical values, various instructions, and the like. The pointing device 512 is a type of an input means that performs selection or execution of various instructions, selection of a processing target, movement of a cursor, and the like. The DVD-RW drive 514 controls reading or writing of various kinds of data with respect to the DVD-RW 513 as an example of a removable recording medium. DVD-R or the like may be employed instead of DVD-RW. The media I/F 516 controls reading or writing (storing) of data with respect to a storage media 515 such as a flash memory.

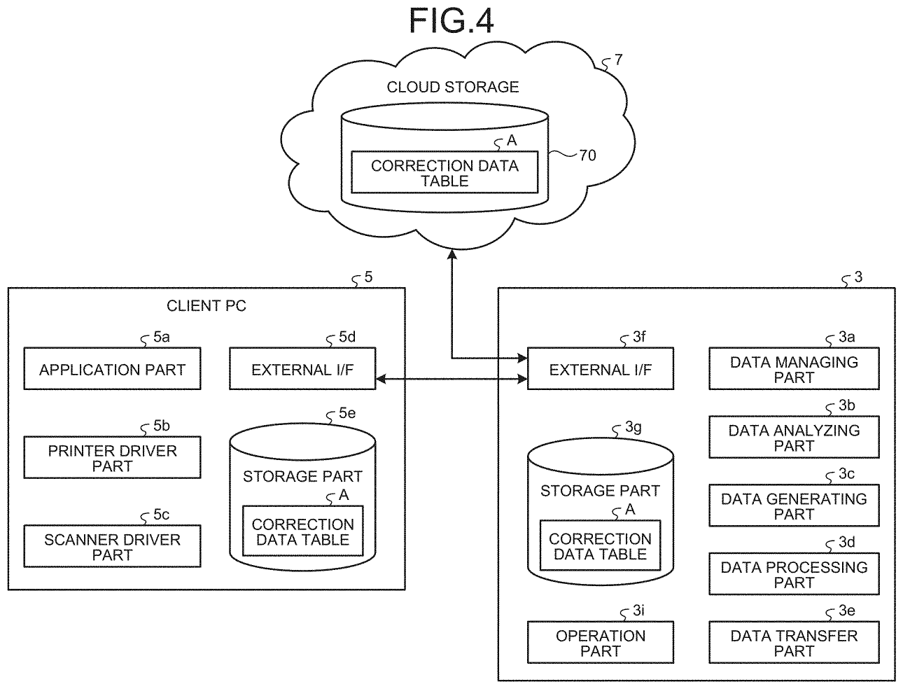

FIG. 4 is a block diagram illustrating an example of a functional configuration of the information processing system 1 according to the present embodiment. FIG. 4 conveniently illustrates functions related to the present invention among the functions possessed by the information processing system 1 according to the present embodiment. In addition, in the present embodiment, image data that is obtained by scanning the printed material with visible light for ordinary reading and invisible light for reading IR toner will be referred to as “original image data”; toner that absorbs a larger amount of visible light than invisible light (infrared rays) as in the case of a black (pure black) toner will be referred to as “first consumable material”; a toner that absorbs a larger amount of invisible light than visible light as in the case of IR toner will be referred to as a “second consumable material”; and a YMC toner for generating process black (black in which cyan, magenta, and yellow are used) will be referred to as a “third consumable material”.

The image forming apparatus 3 includes a data managing part 3a, a data analyzing part 3b, a data generating part 3c, a data processing part 3d, a data transfer part 3e, an external I/F 3f, a storage part 3g that stores therein the correction data table A, and an operation part 3i.

The client PC 5 includes an application part 5a, a printer driver part 5b, a scanner driver part 5c, an external I/F 5d, and a storage part 5e that stores therein the correction data table A.

In addition, the correction data table A is stored in the storage part 70 of the cloud storage 7.

The data managing part 3a stores the correction data table A that the external I/F 3f has received in the storage part 3g. When an IR toner correction mode is enabled, the data managing part 3a uses the original image data and the correction data table to control the data analyzing part 3b, the data generating part 3c, and the data processing part 3d, and executes the IR toner correction processing, which will be described later. The “IR toner correction mode” herein is an operation mode that executes the IR toner correction processing, which will be described later.

The data analyzing part 3b refers to the original image data for generating the printed material utilizing the first consumable material, which absorbs a larger amount of visible light than visible light, and the second consumable material, which absorbs a larger amount of invisible than visible light, and to the correction data table indicating whether invisible light is absorbed for each density value regarding the first consumable material, thereby specifying a pixel having the density value of the first consumable material that absorbs invisible light in the original image data. Specifically, the data analyzing part 3b uses the original image data determine, for each pixel, whether IR toner is utilized. With regard to the pixel utilizing the IR toner, the data analyzing part 3b uses the original image data and the correction data table to determine whether the density value of pure black of the pixel is the density value that absorbs invisible light for reading IR toner.

The data generating part 3c generates corrected image data by correcting the density value of the first consumable material in the pixel specified by the data analyzing part 3b to the density value of the third consumable material that does not absorb invisible light. Specifically, in the pixel that has been determined by the data analyzing part 3b to have the density value of pure black, which absorbs invisible light for reading IR toner, the data generating part 3c converts the density value of pure black into the density value of process black (black in which cyan, magenta, and yellow are used).

The data processing part 3d obtains the original image data that can be obtained by scanning paper information with visible light for ordinary reading and invisible light for reading IR toner.

The data managing part 3a, the data analyzing part 3b, the data generating part 3c, and the data processing part 3d are composed of, for example, the CPU 305, the program RCM 301, and the RAM 306 illustrated in FIG. 2.

The data transfer part 3e transfers the original image data and the corrected image data generated with the IR toner correction processing, which will be described later, to a designated place (for example, the storage part 70 of the cloud storage 7). The data transfer part 3e is composed of the CPU 305 and the network I/F 300 illustrated in FIG. 2.

The external I/F 3g receives the correction data table A from the external I/F 5d of the client PC 5. The external I/F 3g is composed of the CPU 305 and the network I/F 300 illustrated in FIG. 2.

The storage part 3g stores therein the correction data table A that the external I/F 3g has received, and the original image data obtained in the data processing part 3d. The storage part 3g is composed of the HDD 304 and the like illustrated in FIG. 2.

The operation part 3i receives an image generation (printing) request. In addition, the operation part 3i receives enabling/disabling of the IR toner correction mode. For example, the setting item of the “IR toner correction mode” is provided for a GUI of the image forming apparatus 3. The user can set “enabled” “disabled” of the “IR toner correction mode” through the GUI. The set value of “enabled”/“disabled” is automatically stored in the storage part 3g. The operation part 31 is composed of the operation panel 31, the operation part I/F 303, and the like.

The application part 5a executes a drawing application. The application part 5a creates the correction data table, which will be described later.

The printer driver part 5b converts electronic image data for paper image formation into a printable form. The printer driver part 5b performs processing for executing generation, transmission, and the like of print data based on an input operation by a user with the keyboard 511 and the pointing device 512 of the client PC 5.

The scanner driver part 5c instructs, to the image forming apparatus 3, an attribute to read and a reading operation of printed information from the printed material (printed paper image) using the ordinary visible light and invisible light.

The external I/F 5d sends the correction data table A to the external I/F 3g of the image forming apparatus 3.

The storage part 5e stores therein the correction data table A.

Respective functions provided for each of the image forming apparatus 3 and the client PC 5 mentioned above are typically realized as software by execution of a dedicated computer program by a CPU on a RAM. However, not limited to this example, a part or all of the respective functions mentioned above may be realized with dedicated hardware that is designed to execute similar respective functions, for example, with a semiconductor integrated circuit such as an application specific integrated circuit (ASIC), a digital signal processor (DSP), or a field programmable gate array (FPGA), a conventional circuit module, or the like.

### Correction Data Table

The correction data table A will now be described. The correction data table A is a table that indicates, for each density of pure black using a black toner, whether invisible light for reading IR toner is absorbed.

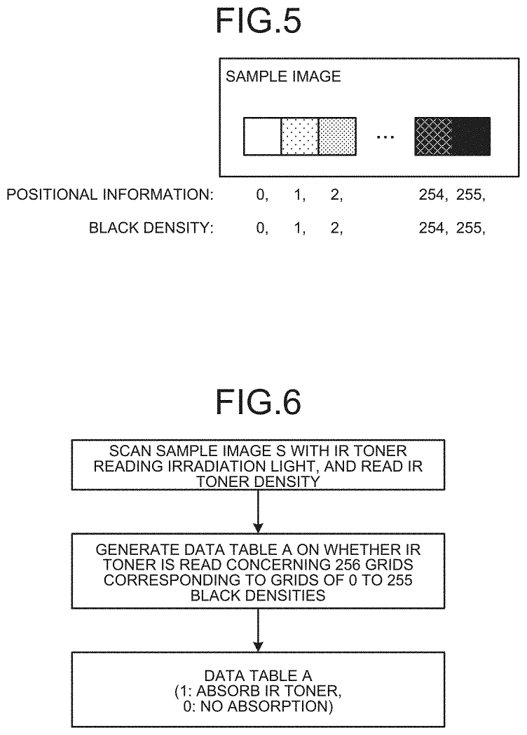

FIG. 5 is a figure illustrating an example of the correction data table A. As illustrated in this figure, for each of 256 densities from 0 to 255 of pure black using a black toner, “1” is assigned when there is absorption of invisible light for reading IR toner, and “0” is assigned when there is no absorption of invisible light for reading IR toner. By using the correction data table A, a pixel having the density value of pure black that absorbs invisible light for reading IR toner can be specified in the original image data.

FIG. 6 is a flow chart illustrating creation processing of the correction data table A. As illustrated in this figure, the application part 5a of the client PC 5 uses the drawing application to create an electronic file in which the density value of pure black is composed of 256 grids from 0 to 255. The printer driver part 5b causes the image forming apparatus 3 to print the created electronic file. The obtained printed material (image hard copy) will be referred to as a sample image S. The scanner driver part 5c can generate the correction data table A by using a scanning function of the image forming apparatus 3 to scan the sample image S with invisible light for reading IR toner. The generated correction data table is stored in the storage part 5e.

### IR Toner Correction Processing

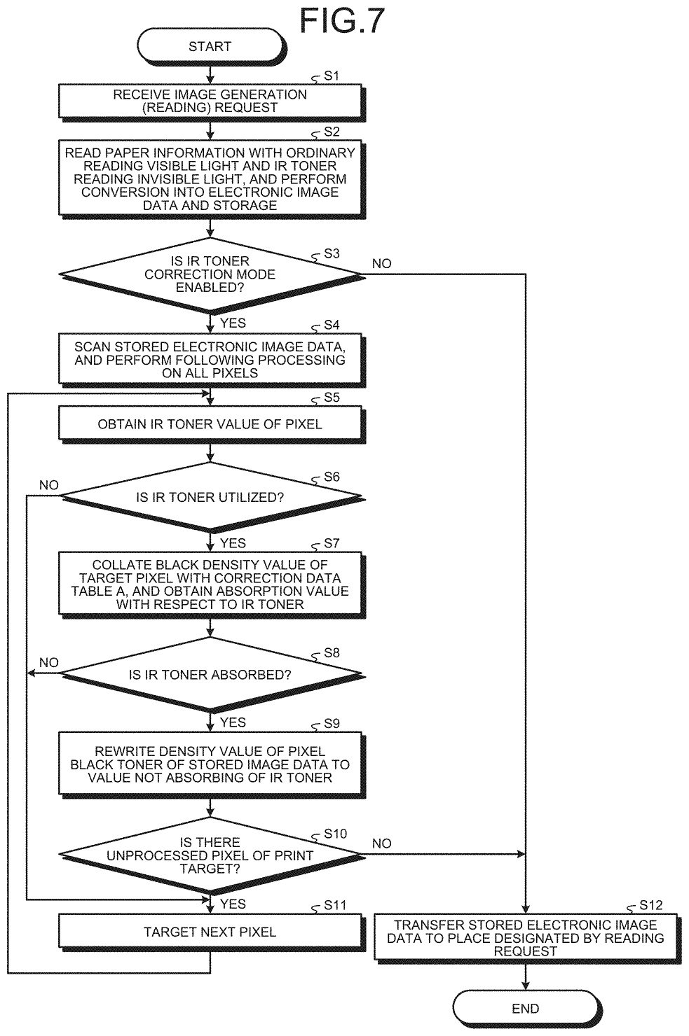

FIG. 7 is a flow chart for describing IR toner correction processing that is executed by the information processing system 1 according to the first embodiment of the present invention. The IR toner correction processing will be described in accordance with this figure.

Firstly, once an image generation (reading) request is received through the operation part 3i (Step S1), the data processing part 3d scans paper printed information that is the target of this IR toner correction processing with visible light for ordinary reading, and generates the original image data. Furthermore, the data processing part 3d scans paper printed information that is the target of this IR toner correction processing with visible light for ordinary reading and invisible light for reading IR toner, and obtains the original image data. The obtained original image data is stored in the storage part 3g (Step S2).

The data managing part 3a determines whether the IR toner correction mode is enabled (Step S3). If it is determined that the IR toner correction mode is not enabled (No at Step S3), the data managing part 3a controls the data transfer part 3e, and transfers the original image data to, for example, a designated place such as the storage part 70 of the cloud storage 7 through a network (Step S12).

On the other hand, if it is determined that the IR toner correction mode is enabled (Yes at Step S3), the data managing part 3a controls the data processing part 3d and scans the original image data (Step S4). The data analyzing part 3b obtains the density value (IR toner value) of a target pixel (in this case, a first pixel) in the scanned original image data (Step S5).

The data analyzing part 3b determines whether the target pixel utilizes an IR toner based on the obtained IR toner value (Step S6). If it is determined that the target pixel does not utilize the IR toner (No at Step S6), the data analyzing part 3b changes the target to the next pixel (in this case, a second pixel) (Step S11), and performs the determination of Step S6. On the other hand, if it is determined that the pixel utilizes the IR toner (Yes at Step S6), the data analyzing part 3b uses the original image data to collate the black density value of the target pixel (i.e., the density value of the pure black toner) with the correction data table A, and obtains the absorption value of invisible light for reading IR toner with respect to the target pixel (Step S7).

Then, the data analyzing part 3b determines whether the black density value of the target pixel is a value that absorbs the IR toner based on the obtained absorption value (Step S8). Specifically, if the obtained absorption value is “1”, the data analyzing part 3b determines that the black density value of the target pixel is the value that absorbs the IR toner (Yes at Step S8). The data generating part 3c rewrites the black density value of the target pixel in the original image data to the same black density value using process black (i.e., the same density value that does not absorb the IR toner) (Step S9). On the other hand, if the obtained absorption value is “0”, the data analyzing part 3b determines that the black density value of the target pixel is a value that does not absorb the IR toner (No at Step S8). The data analyzing part 3b changes the target to the next pixel (in this case, the second pixel) (Step S11), and performs processing of Step S5 and onwards.

The data analyzing part 3b determines whether there is a pixel that is not targeted by the IR toner correction processing (Step S10). If there is such pixel that is not targeted (Yes at Step S10), the data analyzing part 3b performs processing of Step S5 and onwards on a pixel that is displaced by one pixel number (Step S11). On the other hand, if there is no pixel that is not targeted (No at Step S10), the data managing part 3a controls the data transfer part 3e, and transfers the rewritten original image data (corrected image data) to, for example, a designated place such as the storage part 70 of the cloud storage 7 through a network (Step S12).

As has been described above, the image processing apparatus (image forming apparatus) according to the embodiment of the present invention and the information processing system including this image processing apparatus refer to the original image data for generating the printed material that utilizes the first consumable material, which absorbs a larger amount of visible light than invisible light, and the second consumable material, which absorbs a larger amount of invisible light than visible light, and to the correction data table indicating whether invisible light is absorbed for each density value regarding the first consumable material, thereby specifying a pixel having the density value of the first consumable material that absorbs invisible light in the original image data. Furthermore, the corrected image data is generated by correcting the density value of the first consumable material in the specified pixel to the density value of the third consumable material that does not absorb invisible light.

Specifically, a pixel that absorbs invisible light is specified by using the correction data table indicating whether invisible light is absorbed for each density value of black (pure black) toner as the first consumable material, and determining whether invisible light is absorbed for each pixel in the original image data of the printed material including the black toner and the IR toner. The corrected image data is generated by correcting the density value of the black toner in the specified pixel to the density value of process black as the third consumable material that does not absorb invisible light. Accordingly, the generated corrected image data that does not include mixed noise due to absorption of IR by the black toner can be generated instead of the original image data. In addition, by printing the target printed material using the corrected image data instead of the original image data, the printed material using visible light and the printed material using invisible light without influence of IR absorption by the black toner can be provided.

### Second Embodiment

In the first embodiment, the original image data is generated by scanning the target paper printed information with visible light for ordinary reading and invisible light for reading IR toner, and the IR toner correction processing is executed by using the original image data. In contrast, in the case of the IR toner correction processing that is executed by the information processing system 1 according to the present second embodiment, the original image data of the paper printed information previously exists without execution of the above-described scan.

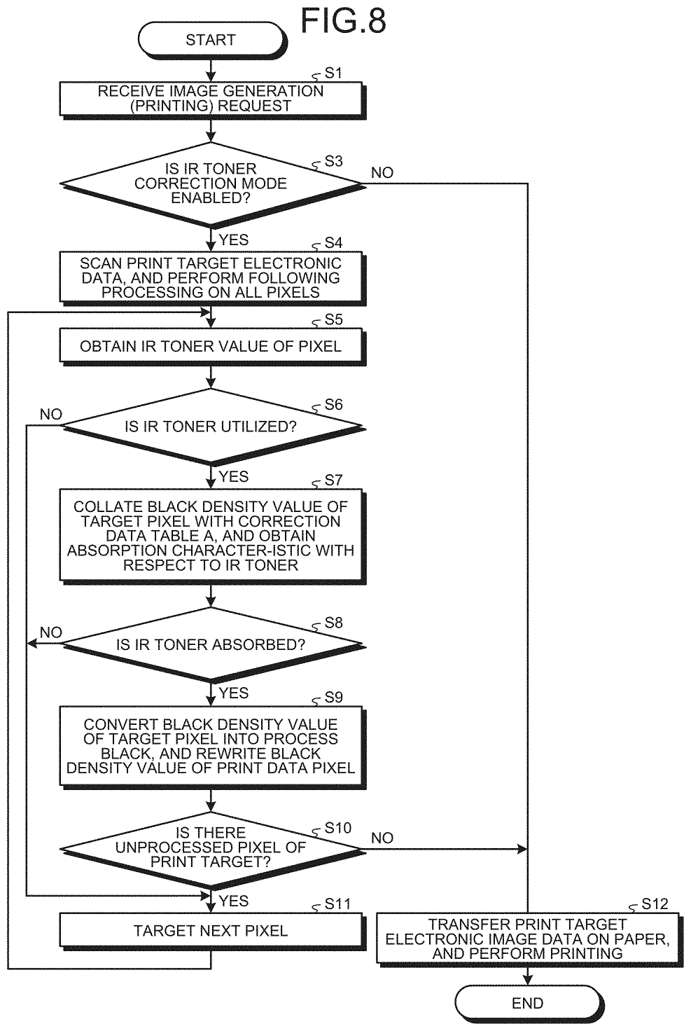

FIG. 8 is a flow chart for describing the IR toner correction processing that is executed by the information processing system 1 according to the second embodiment of the present invention. When compared to the IR toner correction processing according to the first embodiment illustrated in FIG. 7, since the original image data of the paper printed information already exists, the processing of Step S2 illustrated in FIG. 7 is omitted in the flow chart illustrated in FIG. 8.

In such case, the same working effect as the first embodiment can be realized by executing the IR toner correction processing on the original image data of the paper printed information previously stored.

### Third Embodiment

A third embodiment will now be described.

The third embodiment is different from the first embodiment and the second embodiment in that printed information of IR toner having the luminance of gray (0, 255) can be properly detected from the printed material simultaneously utilizing the IR toner and ordinary YMCK toner. In the following, the third embodiment omits the description of the same parts as the first embodiment or the second embodiment, and describes parts that are different from the first embodiment and the second embodiment.

For example, when detecting information on the IR toner having the luminance of gray (0, 255) by scanning the printed material simultaneously utilizing the IR toner and the YMCK toner, there is a problem in that black K toner absorbs scanning IR irradiation light, and a portion that the K toner formed the image is also detected as the IR toner. In order to solve this problem, according to the present embodiment, influence of the black toner can be removed from the printed material simultaneously utilizing the IR toner having the luminance of gray (0, 255) and the ordinary YMCK toner.

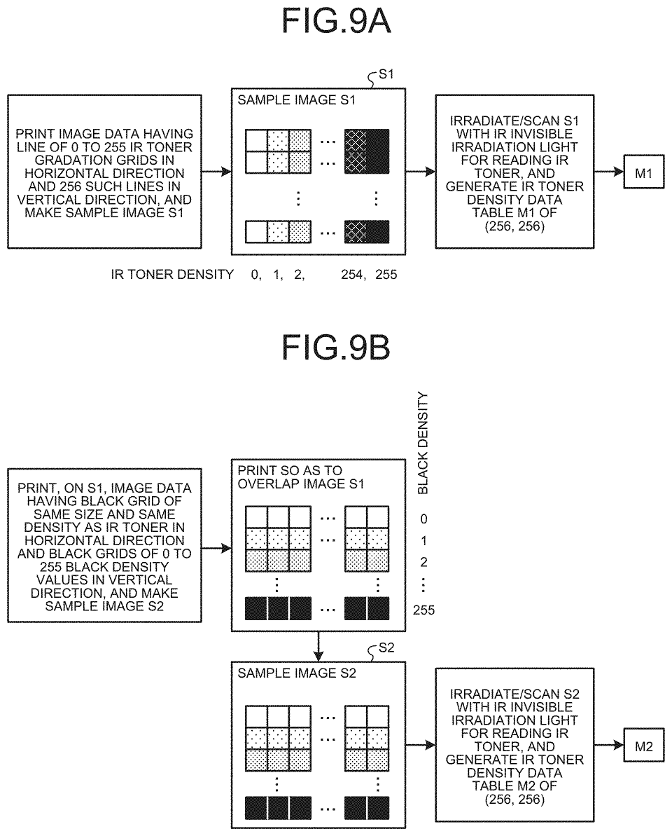

FIG. 9A and FIG. 9B are figures illustrating a flow of creation processing of an IR toner density data table M1 and an IR toner influence detection table M2 according to the third embodiment of the present invention.

Firstly, the creation processing of the IR toner density data table M1 will be described.

As illustrated in FIG. 9A, the application part 5a of the client PC 5 uses the drawing application to create image data (electronic file) in which the horizontal direction is a line that is composed of IR toner grids having 0 to 255 density gradations, and the vertical direction has 256 rows of such lines in the horizontal direction, with an optional color X other than black. The printer driver part 5b causes the image forming apparatus 3 to print the created image data with the IR toner. The obtained printed material (image hard copy) will be referred to as a sample image S1.

The scanner driver part 5c can generate the IR toner density data table M1 of (256, 256) by irradiating/scanning the sample image S1 with invisible light for reading IR toner using the scanning function of the image forming apparatus 3. The generated IR toner density data table M1 is stored in the storage part 5e.

Specifically, the IR toner density data table M1 stores therein, for each of 256 IR toner densities from 0 to 255, normal values of reading with invisible light for reading IR toner when there is no influence of the black toner.

The creation processing of the IR toner influence detection table M2 will now be described.

As illustrated in FIG. 9B, the application part 5a of the client PC 5 uses the drawing application to create, on the sample image S1, image data in which the horizontal direction is composed of black grids having the same size and the same densities as the IR toner and the vertical direction is composed of black grids having black density values from 0 to 255. The printer driver part 5b causes the image forming apparatus 3 to print the created image data. The obtained printed material (image hard copy) will be referred to as a sample image S2.

The scanner driver part 5c can generate the IR toner influence detection table M2 of (256, 256) by irradiating/scanning the sample image S2 with invisible light for reading IR toner using the scanning function of the image forming apparatus 3. The generated IR toner influence detection table M2 is stored in the storage part 5e as the correction data table.

Specifically, the IR toner influence detection table M2 stores therein, for each of 256 IR toner densities from 0 to 255, reading values with invisible light for reading IR toner after being affected by the black toner having densities from 0 to 255.

### Detected Noise Elimination Correction Processing of IR Toner Density Information

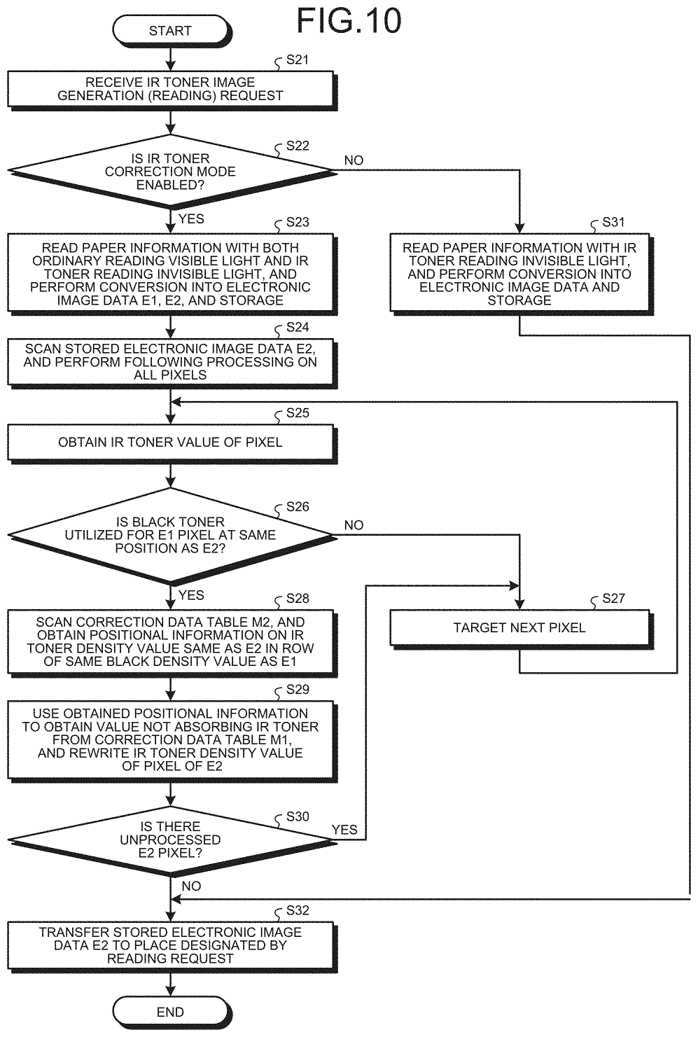

FIG. 10 is a flow chart illustrating detected noise elimination correction processing of IR toner density information that is executed by the information processing system 1 according to the third embodiment of the present invention. The detected noise elimination correction processing of the IR toner density information will be described in accordance with this figure.

Firstly, once receiving an image generation (reading) request through the operation part 3i (Step S21), the data managing part 3a determines whether the IR toner correction mode enabled (Step S22). If it is determined that the IR toner correction mode is not enabled (No at Step S22), the data processing part 3d scans paper printed information that is the target of this correction processing with invisible for reading IR toner, and performs conversion into image data, and performs storage in storage part 3g (Step S31).

Then, the data managing part 3a controls the data transfer part 3e, and transfers the image data to a place that is designated by the image generation (reading) request, for example, a designated place such as the storage part 70 of the cloud storage 7 through the network (Step S32).

On the other hand, if it is determined that the IR toner correction mode is enabled (Yes at Step S22), the processing part 3d scans paper printed information that is the target of this correction processing with visible light for ordinary reading and invisible light for reading IR toner, and performs conversion into image data E1, E2. The obtained image data E1, E2 are stored in the storage part 3g (Step S23).

Then, the data managing part 3a controls the data processing part 3d to scan all of the pixels of the image data E2 one by one (Step S24), and performs the following processing.

Firstly, the data analyzing part 3b obtains the density value (IR toner value) a target pixel n this case, the first pixel) in the scanned image data E2 (Step S25).

Furthermore, the data analyzing part 3b determines whether a pixel of the image data. E1 that is at the same position as the target pixel of the scanned image data E2 utilizes the black toner (Step S26).

If it is determined that the target pixel does not utilize the black toner (No at Step S26), the data analyzing part 3b changes the target to the next pixel (in this case, the second pixel) (Step S27), and performs the processing of Steps S25 to S26.

On the other hand, if it is determined that the target pixel utilizes the black toner (Yes at Step S26), the data analyzing part 3b can recognize that the read IR toner density value of the image data E2 is affected by the black toner. Thus, the data analyzing part 3b scans the IR toner influence detection table M2, and obtains positional information on the same IR toner density value as the image data E2, in the row of the same black density value as the image data E1 (Step S28).

Then, the data generating part 3c uses the obtained positional information to obtain a value with no IR toner absorption from the IR toner dens data table M1, and rewrites the IR toner density value of the pixel in the image data E2 (Step S29).

The data analyzing part 3b determines whether there is an unprocessed pixel of the image data E2 (Step S30). If there is such unprocessed pixel of the image data E2 (Yes at S30), tale target will be changed to the next pixel (in this case, the second pixel) (Step S27), and the processing of Steps S25 to S26 will be performed. On the other hand, if there is no unprocessed pixel of the image data E2 (No at Step S30), the data managing part 3a controls the data transfer part 3e, and transfers the rewritten image data (corrected image data) E2 to a place that is designated by the image generation (reading) request, for example, a designated place such as the storage part 70 of the cloud storage 7 through the network (Step 32).

Specifically the information processing system 1 according to the third embodiment performs detected noise elimination correction processing of IR toner density information mentioned above on all of the pixels of the image data E2, and rewrites a pixel that is affected by the black toner to the IR toner density value at the time of no influence.

In this manner, according to the present embodiment, noise due to the black toner, i.e., a value in which the black toner is detected as the IR toner, previously measured from the 255×255 combinations of each luminance value of the black toner (0, 255) and luminance values of the IR toner (0, 255), and is stored in the IR toner influence detection table M2. Furthermore, when reading printed information of the IR toner with IR irradiation light from the printed material simultaneously utilizing the IR toner and the YMCK toner, the data generating part 3c utilizes the IR toner influence detection table M2 to perform, on the reading result data, rewriting of the target pixel with the original density value of the IR toner.

In this manner, influence of the black toner is eliminated from the printed material simultaneously utilizing the IR toner having the luminance of gray (0, 255) and the ordinary YMCK toner, and printed information of the IR toner can be properly detected.

As illustrated in FIG. 4, in each of the embodiments described above, the data managing part 3a, the data analyzing part 3b, the data generating part 3c, the data processing part 3d, the data transfer part 3e, and the operation part 3i are included in the image forming apparatus 3. However, is not limited thereto.

For example, a part or all of the data managing part 3a, the data analyzing part 3b, the data generating part 3c, the data processing part 3d, the data transfer part 3e, and the operation part 3i may be incorporated not in the image forming apparatus 3 but in the printer driver part 5b of the client PC 5.

In addition, a part or all of the data managing part 3a, the data analyzing part 3b, the data generating part 3c, the data processing part 3d, the data transfer part 3e, and the operation part 3i may be incorporated not in the image forming apparatus 3 but in the scanner driver part 5c of the client PC 5.

Each of the embodiments described above describes an example in which the image forming apparatus is an MPF or a laser printer. However, each of the embodiments is not limited to this example, the image processing apparatus may be a copying machine, an ink jet printer, or the like.

In addition, each of the embodiments described above describes an example in which the first to third consumable materials are toner. However, not limited to this example, technical ideas of the present invention can also be applied to a case in which the first to third consumable materials are inks or ribbons.

In addition, in each of the embodiments described above, a computer program to be executed by the image forming apparatus is provided by being previously incorporated in a ROM or the like.

In addition, in each of the embodiments described above, a computer program to be executed by the image forming apparatus may be provided as a computer program product by being recorded in a computer readable recording medium such as a CD-ROM, flexible disk (FD), CD-R, or digital versatile disc (DVD) as an installable-form or executable-form file.

In addition, in each of the embodiments described above, a computer program to be executed by the image forming apparatus may be provided by being stored on a computer that is connected to a network such as the Internet and downloaded via the network. Furthermore, a computer program to be executed by a diagnosis device of the present embodiment may be provided or distributed via a network such as the Internet.

In addition, in each of the embodiments described above, a computer program to be executed by the image forming apparatus has a module configuration that includes each of the parts mentioned above (such as the communication control part, the determination part, and the like). As actual hardware, a CPU (processor) reads the computer program from the above-described ROM for execution such that each of the parts described above is loaded on a main storage device, and each of the parts is generated on the main storage device.

According to an embodiment, an image processing apparatus, a computer-readable medium, and an image processing method that can improve accuracy of reading of an image that uses a special toner such as IR toner can be provided.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image processing apparatus comprising:
a data analyzing part configured to refer to or image data for generating a printed material utilizing a first consumable material absorbing a larger amount of visible light than invisible light and a second consumable material absorbing a larger amount of invisible light than visible light, and to a correction data table indicating whether invisible light is absorbed for each density value regarding the first consumable material, and specify a pixel having a density value of the first consumable material and absorbing invisible light in the original image data; and
a data generating part configured to correct the density value of the first consumable material in the specified pixel to a density value of a third consumable material not absorbing invisible light, to generate corrected image data.

2. The image processing apparatus according to claim 1, wherein the printed material is scanned with visible light and invisible light, to generate the original image data.

3. The image processing apparatus according to claim 1, wherein the data analyzing part is configured to obtain the original image data stored in a storage part.

4. The image processing apparatus according to claim 1, further comprising as operation part configured to enable or disable a mode to generate the corrected image data.

5. The image processing apparatus according to claim 1, further comprising a data transfer part configured to transfer the corrected image data to a storage part connected to a network.

6. The image processing apparatus according to claim 1, wherein each density value of the first consumable material is scanned with invisible light, to generate the correction data table.

7. The image processing apparatus according to claim 1, wherein
the correction data table previously stores a value in which the first consumable material is detected as the second consumable material in a combination of each luminance value of the first consumable material and a luminance value of the second consumable material, and
the data generating part is configured to refer to the correction data table to perform, on reading result data, rewriting a target pixel with a density value the second consumable material.

8. A non-transitory computer-readable medium including programmed instructions that cause a computer to execute:
referring to original image data for generating a printed material utilizing a first consumable material absorbing a larger amount of visible light than invisible and a second consumable material absorbing a larger amount of invisible light than visible light, and to a correction data table indicating whether invisible light is absorbed for each density value regarding the first consumable material, and specifying a pixel having a density value of the first consumable material and absorbing invisible light in the original image data; and
correcting the density value of the first consumable material in the specified pixel to a density value of a third consumable material not absorbing invisible light, to generate corrected image data.

9. The non-transitory computer-readable medium according to claim 8, wherein the printed material is scanned with visible light and invisible light, to generate the original image data.

10. The non-transitory computer-readable medium according to claim 8, wherein the programmed instructions cause the computer to execute, at the referring, obtaining the original image data stored in a storage part.

11. The non-transitory computer-readable medium according to claim 8, wherein the programmed instructions cause the computer to further execute enabling or disabling a mode to generate the corrected image data.

12. The non-transitory computer-readable medium according to claim 8, wherein the programmed instructions cause the computer to further execute transferring the corrected image data to a storage part connected to a network.

13. The non-transitory computer-readable medium according to claim 8, wherein each density value of the first consumable material is scanned with invisible light, to generate the correction data table.

14. The non-transitory computer-readable medium according to claim 8, wherein
the correction data table previously stores a value in which the first consumable material is detected as the second consumable material in a combination of each luminance value of the first consumable material and a luminance value of the second consumable material, and
the programmed instructions cause the computer to execute, at the correcting, referring to the correction data table to perform, on reading result data, rewriting of a target pixel with a density value of the second consumable material.

15. An image processing method comprising:
referring to original image data for generating a printed material utilizing a first consumable material absorbing a larger amount of visible light than invisible light and a second consumable material absorbing a larger amount of invisible light than visible light, and to a correction data table indicating whether invisible light is absorbed for each density value regarding the first consumable material, and specifying a pixel having a density value of the first consumable material and absorbing invisible light in the original image data; and
correcting the density value of the first consumable material in the specified pixel to a density value of a third consumable material not absorbing invisible light, to generate corrected image data.
